(19) United States
(12) Patent Application Publication
(10) Pub. No.: US 2024/0366977 A1
(43) Pub. Date: Nov. 7, 2024

(54) ABSORBER FOR A FALL PROTECTION SYSTEM

(71) Applicant: Honeywell Safety Products USA, Inc., Charlotte, NC (US)

(72) Inventors: Jan Hrouzek, Brno (CZ); Vaclav Hruza, Brno (CZ); Marketa Kopcova, Brno (CZ)

(21) Appl. No.: 18/310,304

(22) Filed: May 1, 2023

(51) Int. Cl. A62B 35/04

(52) U.S. Cl. CPC A62B 35/04

(57) ABSTRACT

An absorber assembly for a fall protection system is provided. The absorber assembly can include an absorber configured be in a non-deformed state and a deformed state. The absorber assembly can include a connecting pin coupled to the absorber and a swivel that is coupled to the connecting pin. The connecting pin can be configured to rotate by at least five degrees in relation to the absorber when the absorber is in the deformed state.

### TECHNICAL FIELD

The present application relates generally to an absorber assembly. More specifically, the present application relates to an absorber assembly for a fall protection system.

### BACKGROUND

Fall protection systems usually consist of a rope, cable, or the like, which may be coupled to a harness that can be worn by a user. The rope, cable, or the like may be coupled to a shuttle. The shuttle may be engaged with a cable or a railing that is coupled to the structure of a building.

Fall protection systems are provided to reduce the likelihood of serious injury or death to a user after a fall event. However, the inventors have identified numerous deficiencies and problems with the existing technologies in this field. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include systems and apparatuses to provide for improved fall protection systems.

In various aspects, an absorber assembly for a fall protection system is provided. The absorber assembly can include an absorber configured be in a non-deformed state and a deformed state. The absorber assembly can include a connecting pin coupled to the absorber and a swivel that is coupled to the connecting pin. The connecting pin can be configured to rotate by at least five degrees in relation to the absorber when the absorber is in the deformed state.

In various examples, the connecting pin is configured to rotate in relation to the absorber by less than five degrees when the absorber is in the non-deformed state.

In various examples, the absorber is configured to transition from a non-deformed state to a deformed state during a fall event.

In various examples, the absorber assembly includes a fastener that is configured to couple the connecting pin to the absorber.

In various examples, the swivel is rotatably coupled to the connecting pin.

In various examples, the connecting pin defines a pivot axis and a swivel axis that is orthogonal to the pivot axis. The swivel can be configured to rotate on the swivel axis and the connecting pin can be configured to rotate by at least five degrees in relation to the absorber on the pivot axis when the absorber is in the deformed state.

In various examples, the absorber includes a first cut and a second cut that each extend through a thickness of the absorber. The absorber can include an attachment portion defined between the first cut and the second cut. The absorber can include a locking feature that extends from the attachment portion.

In various examples, the absorber includes a bendable member that is configured to bend away from the connecting pin as the absorber transitions from a non-deformed state to a deformed state.

In various examples, the bendable member includes a locking surface that prevents the connecting pin from rotating in relation to the absorber by more than five degrees when the absorber is in the non-deformed state.

In various examples, the connecting pin includes a contact surface that extends substantially parallel to the locking surface of the bendable member. The contact surface can make contact with the locking surface when the absorber is in the non-deformed state.

In various aspects, a fall protection system is provided. The fall protection system can include a shuttle and an absorber assembly coupled to the shuttle. The absorber assembly can include an absorber configured be in a non-deformed state and a deformed state. The absorber assembly can include a connecting pin coupled to the absorber and a swivel that is coupled to the connecting pin. The connecting pin can be configured to rotate by at least five degrees in relation to the absorber when the absorber is in the deformed state.

In various examples, the connecting pin is configured to rotate in relation to the absorber by less than five degrees when the absorber is in the non-deformed state.

In various examples, the absorber is configured to transition from a non-deformed state to a deformed state during a fall event.

In various examples, the absorber assembly further includes a fastener that is configured to couple the connecting pin to the absorber.

In various examples, the swivel is rotatably coupled to the connecting pin.

In various examples, the connecting pin defines a pivot axis and a swivel axis that is orthogonal to the pivot axis. The swivel can be configured to rotate on the swivel axis and the connecting pin can be configured to rotate by at least five degrees in relation to the absorber on the pivot axis when the absorber is in the deformed state.

In various examples, the absorber includes a first cut and a second cut that each extend through a thickness of the absorber. The absorber can include an attachment portion defined between the first cut and the second cut. The absorber can include a locking feature that extends from the attachment portion.

In various examples, the absorber includes a bendable member that is configured to bend away from the connecting pin as the absorber transitions from a non-deformed state to a deformed state.

In various examples, the bendable member includes a locking surface that prevents the connecting pin from rotating in relation to the absorber by more than five degrees when the absorber is in the non-deformed state.

In various examples, the connecting pin includes a contact surface that extends substantially parallel to the locking surface of the bendable member. The contact surface can make contact with the locking surface when the absorber is in the non-deformed state.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure are described with reference to the following figures, which are not necessarily drawn to scale and wherein like reference numerals refer to like parts throughout the various views unless otherwise specified. The components illustrated in the figures may or may not be present in certain embodiments described herein. Some embodiments may include fewer (or more) components than those shown in the figures.

FIG. 1 provides a view of a user utilizing a fall protection system, in accordance with an example embodiment.

FIG. 2 provides a side view of a fall protection system, in accordance with an example embodiment.

FIG. 3 provides a perspective view of an absorber assembly of the fall protection system of FIG. 2, in accordance with an example embodiment.

FIG. 4 provides a perspective view of a connecting pin of the absorber assembly of FIG. 3, in accordance with an example embodiment.

FIG. 5 provides a side view of an absorber of the absorber assembly of FIG. 3 in a non-deformed state, in accordance with an example embodiment.

FIG. 6 provides a side view of the absorber of FIG. 5 in a deformed state, in accordance with an example embodiment.

FIG. 7 provides a side view of an absorber assembly in a non-deformed state, in accordance with an example embodiment.

FIG. 8 provides a side view of the absorber assembly of FIG. 7 in a deformed state, in accordance with an example embodiment.

FIG. 9 provides a perspective view of the absorber of FIG. 5 in a non-deformed state, in accordance with an example embodiment.

### DETAILED DESCRIPTION

One or more embodiments are now more fully described with reference to the accompanying drawings, wherein like reference numerals are used to refer to like elements throughout and in which some, but not all embodiments of the inventions are shown. In the following description, for purposes of explanation, numerous specific details are set forth in order to provide a thorough understanding of the various embodiments. It is evident, however, that the various embodiments can be practiced without these specific details. It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements.

As used herein, the term “exemplary” means serving as an example, instance, or illustration. Any aspect or design described herein as “exemplary” is not necessarily to be construed as preferred or advantageous over other aspects or designs. Rather, use of the word exemplary is intended to present concepts in a concrete fashion. In addition, while a particular feature may be disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the term “positioned directly on” refers to a first component being positioned on a second component such that they make contact. Similarly, as used herein, the term “positioned directly between” refers to a first component being positioned between a second component and a third component such that the first component makes contact with both the second component and the third component. In contrast, a first component that is “positioned between” a second component and a third component may or may not have contact with the second component and the third component. Additionally, a first component that is “positioned between” a second component and a third component is positioned such that there may be other intervening components between the second component and the third component other than the first component.

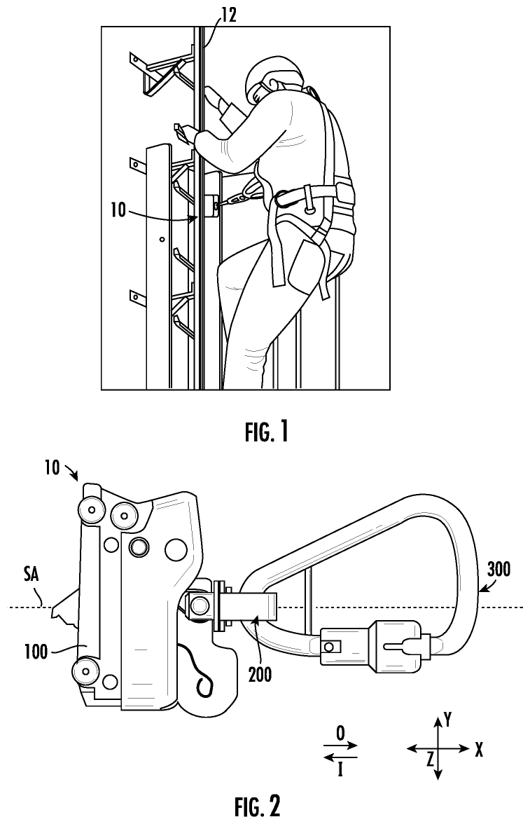

Referring now to FIG. 1 and FIG. 2, a view of a user using a fall protection system 10 (FIG. 1) is provided, and a side view of the fall protection system 10 is provided (FIG. 2), in accordance with an example embodiment. The fall protection system 10 can define an X direction, a Y direction that is orthogonal to the X direction, and a Z direction that is orthogonal to the X direction and the Y direction. The fall protection system 10 can define an outward direction O and an opposite inward direction I that each extend generally in the X direction.

The fall protection system 10 can include a shuttle 100. The shuttle 100 can be configured to move along a rail 12, generally in the Y direction. As will be appreciated, the rail 12 may extend at an angle away from a vertical direction. For example, the rail may be at approximately a 15 degree angle (e.g., between 10 degrees and 20 degrees) in relation to the vertical direction. Therefore, the Y direction may also extend at an angle away from the vertical direction (e.g., at approximately a 15 degree angle in relation to the vertical direction). The fall protection system 10 can include an absorber assembly 200. The absorber assembly 200 can be coupled to the shuttle 100. The shuttle 100 can be configured to at least partially house the absorber assembly 200.

The fall protection system 10 can include an attachment mechanism 300. The attachment mechanism 300 can be coupled to the absorber assembly 200. The attachment mechanism 300 can be configured as a carabiner. The attachment mechanism 300 can be configured to be indirectly attached to a user. For example, a user may wear a harness that is coupled to a rope, cable, or the like, which may be coupled to the attachment mechanism 300.

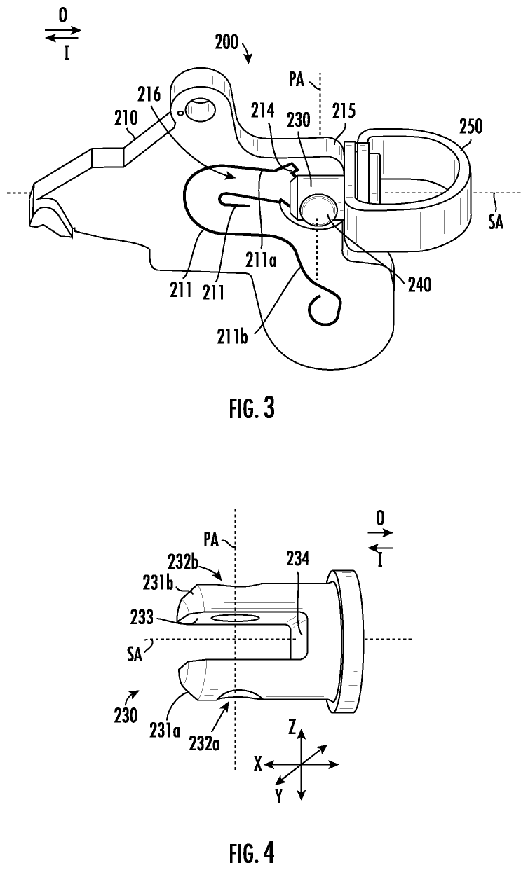

Referring now to FIG. 3, a perspective view of the absorber assembly 200 of the fall protection system 10 of FIG. 2 is provided, in accordance with an example embodiment. The absorber assembly 200 can include an absorber 210. The absorber 210 can be manufactured from a malleable material. For example, the absorber 210 can be manufactured from a metal. The metal can be a ductile steel material, such as stainless steel.

As depicted in FIG. 3, the absorber 210 can be configured to be in a non-deformed state. When the absorber 210 is in the non-deformed state, the absorber 210 can extend generally along a plane defined by the X direction and the Y direction. The absorber 210 can include one or more cuts 211 that extend substantially through a thickness of the absorber 210. In various example, at least one of the one or more cuts 211 can extend completely through a thickness of the absorber 210. For example, and as depicted in the figures, the absorber 210 can include two cuts 211, a first cut 211a and a second cut 211b that each extend completely through a thickness of the absorber 210. At least one of the one or more cuts 211 can be at least partially meandering such that it follows a partially winding path.

The absorber assembly 200 can include a connecting pin 230. The connecting pin 230 can define a pivot axis PA. When the absorber 210 is in a non-deformed state, the pivot axis PA may extend in the Z direction. The connecting pin 230 can define a swivel axis SA that is orthogonal to the pivot axis PA. When the absorber 210 is in a non-deformed state, the swivel axis SA may extend in the X direction.

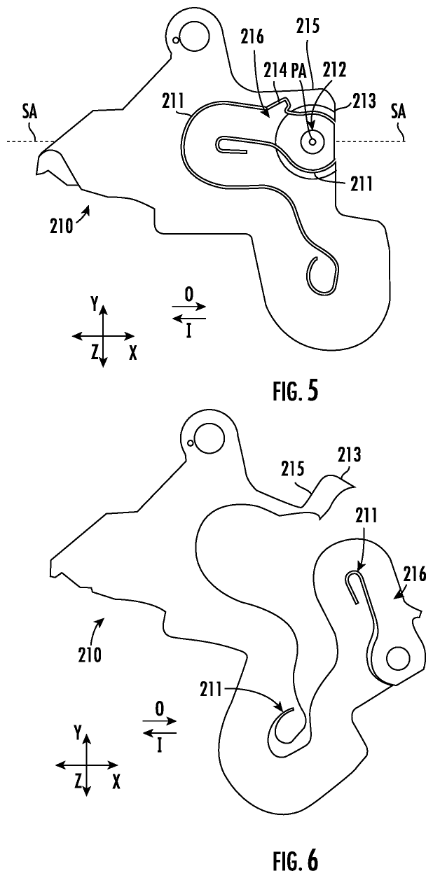

The connecting pin 230 can be coupled to the absorber 210. The absorber assembly 200 can include a fastener 240 to couple the connecting pin 230 to the absorber 210. The fastener 240 can be configured as a rivet. The fastener 240 can be configured to allow rotation of the connecting pin 230 relative to the absorber 210. As will be discussed, the connecting pin 230 can be configured to pivot on the pivot axis PA when the absorber 210 is in a deformed state, as depicted in FIG. 6. For example, the connecting pin 230 may be allowed to pivot by at least five degrees, such as at least 15 degrees, such as at least 30 degrees, such as at least 45 degrees on the pivot axis PA when the absorber 210 is in the deformed state. The absorber 210 can be configured to prevent the connecting pin 230 from rotating on the pivot axis PA when the absorber 210 is in a non-deformed state, as depicted in FIG. 3. For example, the connecting pin 230 may be prevented from pivoting more than 5 degrees when the absorber 210 is in the non-deformed state. Stated differently, the connecting pin 230 may be configured to pivot less than 5 degrees, such as less than 3 degrees, such as less than 1 degree when the absorber 210 is in the non-deformed state.

The absorber assembly 200 can include a swivel 250. The swivel 250 can be coupled to the connecting pin 230. For example, the swivel 250 can be rotatably coupled to the connecting pin 230. The swivel 250 can be configured to rotate at least partially on the swivel axis SA that is defined by the connecting pin 230. The swivel 250 can be D-shaped. The swivel 250 can be configured to allow a rope, cable, or the like, to be coupled thereto.

Referring now to FIG. 5, a side view of the absorber 210 of the absorber assembly 200 of FIG. 3 is provided, in accordance with an example embodiment. In various examples, the absorber 210 includes an attachment portion 216. The attachment portion 216 can be defined between two cuts 211 and can be proximate to a bottom of the absorber 210. The attachment portion 216 can include an orifice 212 for positioning the fastener 240 (FIG. 3) within.

The attachment portion 216 of the absorber 210 can include a locking feature 214. In various examples, and as depicted in FIG. 5, the locking feature 214 can protrude from a body of the attachment portion 216. In various examples, and as depicted in FIG. 5, the locking feature 214 can be generally rectangular, with rounded or non-rounded corners, and angled in the outward direction O. For example, the locking feature 214 can be generally rectangular shaped and can have a side that extends downward from a plane defined by the Y direction and the Z direction by approximately 60 degrees, such as at least 40 degrees and up to 80 degrees, such as at least 50 degrees and up to 70 degrees, such as at least 55 degrees and up to 65 degrees, and/or within manufacturing tolerances.

The absorber 210 can include a bendable member 215. The bendable member 215 can be positioned proximate to the attachment portion 216 and the locking feature 214 of the attachment portion 216. As will be discussed in more detail, the bendable member 215 and the attachment portion 216 are configured to move away from each other when a sufficient amount of force is exerted on the attachment portion 216 in the outward direction O. As will also be discussed, when the sufficient amount of force (e.g., a force greater than 2 kilonewton (kN)) in the outward direction O, in the Y direction (e.g., the negative Y direction, which may be a downward direction), or a combination thereof, is exerted on the attachment portion 216, the locking feature 214 exerts a vector force on the bendable member 215 that includes an outward component in the X direction and an orthogonal component in the Y direction because the locking feature 214 is angled in the outward direction O relative to the plane defined by the Y direction and the Z direction by approximately 60 degrees. When the bendable member 215 and the attachment portion 216 move away from each other, the absorber 210 is transitioning from the non-deformed state to the deformed state, which will also be discussed in more detail.

The bendable member 215 of the absorber 210 can include a locking surface 213. The locking surface 213 can be defined on an outer-most surface of the bendable member 215. The locking surface 213 can extend generally (e.g., within 10 degrees, such as within 5 degrees, such as within 2 degrees) along a plane defined by the Y direction and the Z direction. The connecting pin 230 (FIG. 3) of the absorber assembly 200 can be configured to be positioned proximate to and/or be configured to make contact with the locking surface 213 when the absorber 210 is in the non-deformed state. As will be discussed in more detail, positioning the connecting pin 230 proximate to and/or such that it makes contact with the locking surface 213 may prevent the connecting pin 230 from pivoting on the pivot axis PA when the absorber 210 is in the non-deformed state. As will be appreciated, when the bendable member 215 and the attachment portion 216 of the absorber 210 move away from each other and the absorber 210 is in the deformed state, the connecting pin 230 is allowed to pivot on the pivot axis PA because the locking surface 213 is no longer proximate to and/or making contact with the connecting pin 230.

Referring briefly to FIG. 4, a perspective view of the connecting pin 230 of the absorber assembly 200 of the fall protection system 10 is provided, in accordance with an example embodiment. The connecting pin 230 can define the swivel axis SA for the swivel 250 to rotate on. The connecting pin 230 can include a first prong 231a and a second prong 231b. The first prong 231a and the second prong 231b can extend generally in the inward direction I from a body of the connecting pin 230.

The first prong 231a can include a first orifice 232a and the second prong 231b can include a second orifice 232b. The first orifice 232a and the second orifice 232b can define the pivot axis PA that the connecting pin 230 pivots on when the absorber 210 is in the deformed state. The first orifice 232a and the second orifice 232b can be configured to allow the fastener 240 (FIG. 3) of the absorber assembly 200 to be positioned within.

The connecting pin 230 can have an interior surface 233. The interior surface 233 can include a contact surface 234. The contact surface 234 can extend generally along a plane defined by the Y direction and the Z direction. In various examples, the contact surface 234 of the connecting pin 230 is positioned proximate to and/or positioned such that it makes contact with the locking surface 213 of the absorber 210 (FIG. 5) when the absorber 210 is in the non-deformed state. Positioning the contact surface 234 of the connecting pin 230 proximate to and/or such that it makes contact with the locking surface 213 of the absorber 210 (FIG. 5) may prevent the connecting pin 230 from pivoting on the pivot axis PA when the absorber 210 is in the non-deformed state.

Referring now to FIG. 6, a side view of the absorber 210 of FIG. 5 is provided, in accordance with an example embodiment. More specifically, FIG. 6 depicts the absorber 210 of FIG. 5 in the deformed state. When a sufficient amount of force is exerted on the attachment portion 216 of the absorber 210, the attachment portion 216 moves in the outward direction O. Also, as discussed, when the sufficient amount of force in the outward direction O, the Y direction, or a combination thereof, is exerted on the attachment portion 216, the locking feature 214 exerts a vector force on the bendable member 215; the vector force may include an outward component in the X direction and a orthogonal component in the Y direction because the locking feature 214 is angled in the outward direction O relative to the plane defined by the Y direction and the Z direction by approximately 60 degrees. When the sufficient amount of force is exerted on the attachment portion 216 in the outward direction O, the bendable member 215 and the attachment portion 216 move away from each other. For example, the attachment portion 216 moves generally in the outward direction O and downward in the Y direction, whereas the bendable member 215 pivots upward and away from the attachment portion 216. When the bendable member 215 and the attachment portion 216 move away from each other, the absorber 210 transitions from the non-deformed state (FIG. 5) to the deformed state (FIG. 6).

When the absorber 210 is in the deformed state, as depicted in FIG. 6, the contact surface 234 of the connecting pin 230 is no longer positioned proximate to and/or positioned such that it makes contact with the locking surface 213 of the absorber 210. As such, the connecting pin 230 is allowed to pivot on the pivot axis PA when the absorber 210 is in the deformed state. This may be beneficial because not allowing the connecting pin 230 to pivot during a fall event may exert an undesirable force on the attachment portion 216 of the absorber 210.

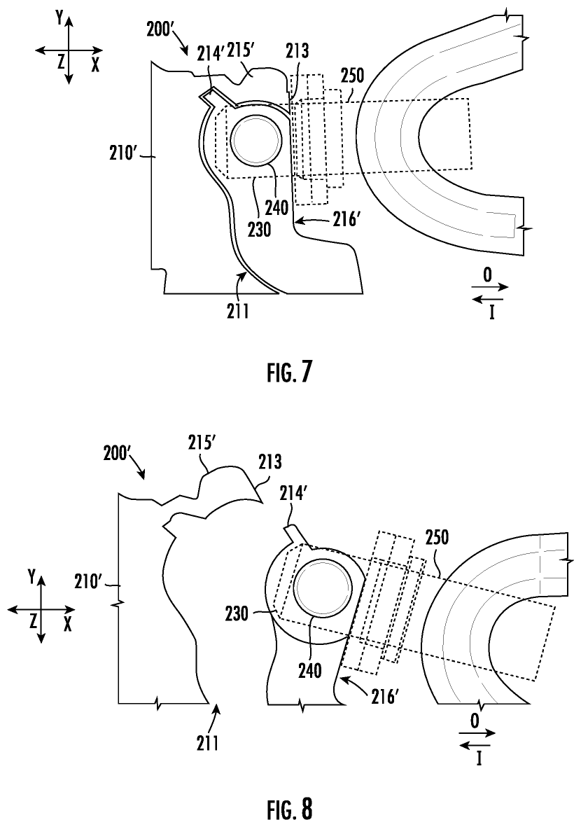

Referring now to FIGS. 7 and 8, side views of an absorber assembly 200′ are provided, in accordance with an example embodiment. More specifically, FIG. 7 provides a side view of the absorber 210′ of the absorber assembly 200′ in the non-deformed state, whereas FIG. 8 provides a side view of the absorber 210′ of the absorber assembly 200′ in the deformed state. The absorber assembly 200′ of FIGS. 7 and 8 can be configured similarly to the absorber assembly 200 of FIG. 3.

In various examples, and as depicted in FIG. 7, the locking feature 214′ of the absorber 210′ can be angled in the upward direction D relative to a plane defined by the Y direction and the Z direction by approximately 50 degrees, such as at least 30 degrees and up to 70 degrees, such as at least 40 degrees and up to 60 degrees, such as at least 45 degrees and up to 55 degrees.

The absorber 210′ can include a bendable member 215′ that is configured to bend away from the attachment portion 216′ when a sufficient force in the outward direction O is exerted on the attachment portion 216′. For example, when a sufficient force in the outward direction O is exerted on the attachment portion 216′, a force is exerted on the bendable member 215′ by the locking feature 214′. Because of the angle of the locking feature 214′ partially in the inward direction I, the locking feature 214′ exerts a vector force on the bendable member 215′. The force may include an inward component in the X direction and an orthogonal component in the Y direction. The vector force exerted on the bendable member 215′ by the locking feature 214′ may cause the bendable member 215′ and the attachment portion 216′ to move away from each other. When the bendable member 215′ and the attachment portion 216′ move away from each other, the absorber 210′ transitions from the non-deformed state (FIG. 7) to the deformed state (FIG. 8).

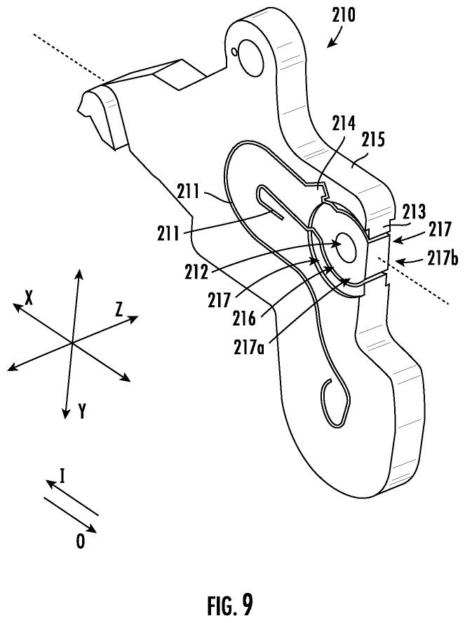

Referring now to FIG. 9, a perspective view of the absorber 210 of FIG. 5 in the non-deformed state is provided, in accordance with an example embodiment. The absorber 210 can include one or more depression 217. For example, the absorber 210 can include a first depression 217a on a first side of the absorber 210 and a second depression 217b on an opposite, second side of the absorber 210. Each depression 217 can have a circular shape, as viewed from the Z direction. Each depression 217 may be configured to allow the first prong 231a and the second prong 231b of the connecting pin 230 (FIG. 4) to pivot on the PA axis within the depression 217.

Providing an absorber 210 with one or more depressions 217 may reduce an overall weight of the absorber assembly 200. For example, the removal of material to form the depressions 217 reduces the weight of the absorber 210. Also, the depressions 217 may allow the size of the connecting pin 230 to be reduced because the first prong 231a and the second prong 231b of the connecting pin 230 may be positioned closer to each other.

Referring back to FIG. 3 and FIG. 7, the absorber assemblies 200, 200′ of the present disclosure have various benefits. For example, the absorber assemblies 200, 200′ may absorb a portion of the force caused by a fall event that would otherwise be transmitted to the user experiencing the fall event.

Also, by allowing the connecting pin 230 to pivot on the pivot axis PA, a force exerted by the user experiencing the fall event on the absorber 210 is reduced. For example, conventional absorber assemblies may be equipped with a swivel that rotates on the swivel axis SA but may not be equipped with a swivel that is also allowed to pivot on an orthogonal axis, such as the pivot axis PA. As such, during a fall event, the connecting means of the swivel of conventional absorber assemblies may remain stationary relative to the portion of the absorber that it is attached to during a fall event. Therefore, an undesirable force may be transformed from the swivel to the conventional absorber. In contrast, the connecting pin 230 of the present disclosure is allowed to pivot on the pivot axis PA during a fall event, which reduces the amount of force exerted on the absorber 210, 210′ by the connecting pin 230. Also, by allowing the connecting pin 230 of the present disclosure to pivot on the pivot axis PA during a fall invention, a maximum bearing capability of the absorber assemblies 200, 200′ may be increased and stress on individual components of the assembly may be reduced.

Additionally, the absorber assemblies 200, 200′ of the present disclosure may prevent the connecting pin 230 and/or the swivel 250 from pivoting on the pivot axis PA when the absorber 210, 210′ is in the non-deformed state (e.g., while the fall protection system 10 is in use and a fall event has not occurred). This may be beneficial because it reduces wear on the connecting pin 230 and/or the absorber 210, 210′.

### CONCLUSION

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the appended claims below. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An absorber assembly for a fall protection system, the absorber assembly comprising:
an absorber configured be in a non-deformed state and a deformed state;
a connecting pin coupled to the absorber; and
a swivel that is coupled to the connecting pin,
wherein the connecting pin is configured to rotate by at least five degrees in relation to the absorber when the absorber is in the deformed state.

2. The absorber assembly of claim 1, wherein the connecting pin is configured to rotate in relation to the absorber by less than five degrees when the absorber is in the non-deformed state.

3. The absorber assembly of claim 1, wherein the absorber is configured to transition from a non-deformed state to a deformed state during a fall event.

4. The absorber assembly of claim 1, further comprising a fastener that is configured to couple the connecting pin to the absorber.

5. The absorber assembly of claim 1, wherein the swivel is rotatably coupled to the connecting pin.

6. The absorber assembly of claim 1, wherein the connecting pin defines a pivot axis and a swivel axis that is orthogonal to the pivot axis, wherein the swivel is configured to rotate on the swivel axis and the connecting pin is configured to rotate by at least five degrees in relation to the absorber on the pivot axis when the absorber is in the deformed state.

7. The absorber assembly of claim 1, wherein the absorber comprises:
a first cut and a second cut that each extend through a thickness of the absorber;
an attachment portion defined between the first cut and the second cut; and
a locking feature extending from the attachment portion.

8. The absorber assembly of claim 1, wherein the absorber comprises a bendable member that is configured to bend away from the connecting pin as the absorber transitions from a non-deformed state to a deformed state.

9. The absorber assembly of claim 7, wherein the bendable member comprises a locking surface that prevents the connecting pin from rotating in relation to the absorber by more than five degrees when the absorber is in the non-deformed state.

10. The absorber assembly of claim 7, wherein the connecting pin comprises a contact surface that extends substantially parallel to the locking surface of the bendable member, wherein the contact surface makes contact with the locking surface when the absorber is in the non-deformed state.

11. A fall protection system comprising:
a shuttle; and
an absorber assembly coupled to the shuttle, the absorber assembly comprising:
an absorber configured be in a non-deformed state and a deformed state;
a connecting pin coupled to the absorber; and
a swivel that is coupled to the connecting pin,
wherein the connecting pin is configured to rotate by at least five degrees in relation to the absorber when the absorber is in the deformed state.

12. The fall protection system of claim 11, wherein the connecting pin is configured to rotate in relation to the absorber by less than five degrees when the absorber is in the non-deformed state.

13. The fall protection system of claim 11, wherein the absorber is configured to transition from a non-deformed state to a deformed state during a fall event.

14. The fall protection system of claim 11, wherein the absorber assembly further comprises a fastener that is configured to couple the connecting pin to the absorber.

15. The fall protection system of claim 11, wherein the swivel is rotatably coupled to the connecting pin.

16. The fall protection system of claim 11, wherein the connecting pin defines a pivot axis and a swivel axis that is orthogonal to the pivot axis, wherein the swivel is configured to rotate on the swivel axis and the connecting pin is configured to rotate by at least five degrees in relation to the absorber on the pivot axis when the absorber is in the deformed state.

17. The fall protection system of claim 11, wherein the absorber comprises:
a first cut and a second cut that each extend through a thickness of the absorber;
an attachment portion defined between the first cut and the second cut; and
a locking feature extending from the attachment portion.

18. The fall protection system of claim 11, wherein the absorber comprises a bendable member that is configured to bend away from the connecting pin as the absorber transitions from a non-deformed state to a deformed state.

19. The fall protection system of claim 17, wherein the bendable member comprises a locking surface that prevents the connecting pin from rotating in relation to the absorber by more than five degrees when the absorber is in the non-deformed state.

20. The fall protection system of claim 17, wherein the connecting pin comprises a contact surface that extends substantially parallel to the locking surface of the bendable member, wherein the contact surface makes contact with the locking surface when the absorber is in the non-deformed state.
